(19) United States
(12) Patent Application Publication
(10) Pub. No.: US 2026/0151798 A1
(43) Pub. Date: Jun. 4, 2026

(54) ULTRASONIC SENSOR, FINGERPRINT RECOGNITION APPARATUS, AND ELECTRONIC DEVICE

(71) Applicant: Egis Technology Inc., Taipei City (TW)

(72) Inventors: BRUCE C. S. CHOU, Taipei City (TW); CHEN-CHIH FAN, Taipei City (TW)

(21) Appl. No.: 19/379,933

(22) Filed: Nov. 5, 2025

Related U.S. Application Data
(60) Provisional application No. 63/728,117, filed on Dec. 4, 2024.

(30) Foreign Application Priority Data
Sep. 19, 2025 (CN) 2025220220667

(51) Int. Cl. B06B 1/06; B06B 1/02; G06V 40/13

(52) U.S. Cl. CPC B06B 1/0648; B06B 1/0207; G06V 40/1306

(57) ABSTRACT

An ultrasonic sensor includes a substrate, a piezoelectric transducer on the substrate, a first chip on the substrate and electrically connected to the piezoelectric transducer. The first chip includes one type of a transmitter chip, a receiver chip, or an integrated chip. The integrated chip integrates circuits of the transmitter chip and the receiver chip. The ultrasonic sensor can shorten the transmission path between the piezoelectric transducer and the first chip, and help to reduce the size of the sensor.

### CROSS-REFERENCE TO RELATED APPLICATION AND CLAIM OF PRIORITY

This application claims the benefit under 35 USC § 119 of U.S. patent application Ser. No. 63/728,117 filed on Dec. 4, 2024, Chinese Patent Application No. 2025220220667 filed on Sep. 19, 2025, in the Chinese Intellectual Property Office, the entire disclosure of which are incorporated herein by reference for all purposes.

### BACKGROUND

### 1. Technical Field

This application generally relates to the technical field of sensors. More specifically, this application relates to an ultrasonic sensor, a fingerprint recognition apparatus, and an electronic device.

### 2. Background Art

In the field of ultrasonic sensors, the existing technical solutions generally construct an ultrasonic sensing apparatus by integrating a piezoelectric transducer and a thin film transistor circuit (TFT circuit) on a glass substrate, and connecting the TFT circuit to an application specific integrated circuit chip (ASIC) via a flexible printed circuit. The ASIC chip is configured to control and drive the emission of ultrasonic signals, and/or control and receive signals sensed by the piezoelectric transducer for computation. For example, as shown in FIG. 1, the ultrasonic sensing apparatus 100 includes a glass substrate 110 and a flexible printed circuit 120. The glass substrate 110 is provided with a piezoelectric transducer 111 and a TFT circuit 112, and the flexible printed circuit 120 is provided with an ASIC chip 121.

However, this technique has many limitations. On one hand, the TFT manufacture procedure is a low-level procedure, and the produced TFT circuit has a relatively large area, so that a large amount of space needs to be reserved for the TFT circuit on the glass substrate, which greatly limits the size of the piezoelectric transducer. For example, when the glass substrate has a size of 12 mm×10 mm, the size of the piezoelectric transducer can only reach 8 mm×8 mm. On the other hand, the transmission distance between the ASIC chip and the piezoelectric transducer through the flexible printed circuit 120 is relatively long, affecting the signal transmission. Therefore, it is difficult for the existing ultrasonic sensing apparatus to meet the requirements for modern electronic devices on miniaturized and high-performance sensors.

In view of this, there is an urgent need for an ultrasonic sensor solution which can help to realize miniaturization of the ultrasonic sensor and improve the performance of the sensor.

### SUMMARY

To address at least one or more of the above technical problems, this application proposes, in various aspects, solutions of an ultrasonic sensor, a fingerprint recognition apparatus, and an electronic device.

In a first aspect, this application provides an ultrasonic sensor, including: a substrate; a piezoelectric transducer on the substrate; a first chip on the substrate and electrically connected to the piezoelectric transducer, wherein the first chip includes one type of a transmitter chip, a receiver chip, or an integrated chip, wherein the integrated chip integrates circuits of the transmitter chip and the receiver chip.

In some embodiments, the ultrasonic sensor further includes a second chip, wherein the second chip includes one type of the transmitter chip or the receiver chip, while the first chip includes the other type of the transmitter chip or the receiver chip; and at least one of the first chip or the second chip is disposed on the substrate at a side edge of the piezoelectric transducer.

In other embodiments, the first chip and the second chip are disposed on the substrate on the same side of the piezoelectric transducer, or on the substrate at two sides of the piezoelectric transducer, respectively.

In other embodiments, the ultrasonic sensor further includes: a first connection plate connected to the substrate; and the second chip is disposed on the first connection plate.

In still other embodiments, the first connection plate includes a connection part and an extension part, wherein the connection part is connected to the substrate, the extension part is connected to the connection part, and the second chip is disposed on the extension part.

In some embodiments, a ratio of an area of the piezoelectric transducer to an area of a surface of the substrate where the piezoelectric transducer is located is greater than 0.6.

In other embodiments, the piezoelectric transducer includes a lower electrode layer, a piezoelectric material layer, and an upper electrode layer, where the piezoelectric material layer is located between the lower electrode layer and the upper electrode layer, and the lower electrode layer is located between the substrate and the piezoelectric material layer; and the ultrasonic sensor further includes a protective layer, wherein the protective layer covers the upper electrode layer and a surface of the substrate where the piezoelectric transducer is located, and exposes a first connection pad led out from the lower electrode layer and a second connection pad led out from the upper electrode layer.

In still other embodiments, the exposed first connection pad is electrically connected to one type of the transmitter chip or the receiver chip, and the exposed second connection pad is electrically connected to the other type of the transmitter chip or the receiver chip; or the exposed first and second connection pads are electrically connected to the integrated chip.

In some embodiments, the ultrasonic sensor further includes a second connection plate for connecting an external system, wherein the second connection plate is connected to the substrate, and the number of output connection pads on the substrate for connecting the second connection plate is smaller than the number of first connection pads and/or second connection pads.

In other embodiments, the lower electrode layer includes a plurality of strip-shaped lower electrodes distributed in parallel, wherein each lower electrode leads out a corresponding first connection pad; the upper electrode layer includes a plurality of strip-shaped upper electrodes distributed in parallel, wherein each upper electrode leads out a corresponding second connection pad; and the plurality of lower electrodes in the lower electrode layer and the plurality of upper electrodes in the upper electrode layer are orthogonally arranged.

In still other embodiments, each lower electrode has a width of 30 μm to 150 μm; and a physical pitch between two adjacent lower electrodes is 50 μm to 200 μm, wherein the physical pitch is a center-to-center distance of the two adjacent lower electrodes.

In some embodiments, each upper electrode has a width of 30 μm to 150 μm; and a physical pitch between two adjacent upper electrodes is 50 μm to 200 μm.

In other embodiments, the lower electrode layer has a thickness of 0.3 μm to 1.5 μm.

In still other embodiments, the piezoelectric material layer has a thickness of 5 μm to 30 μm.

In some embodiments, the upper electrode layer has a thickness of 0.3 μm to 1.5 μm.

In other embodiments, the protective layer has a thickness of 3 μm to 40 μm; or the protective layer has a thickness of 3 μm to 20 μm; or the protective layer has a thickness of 12 μm to 36 μm; or the protective layer has a thickness of 12 μm to 30 μm.

In still other embodiments, a plurality of first connection pads are linearly arranged, and a physical pitch between two adjacent first connection pads is 70 μm; and a plurality of second connection pads are linearly arranged, and a physical pitch between two adjacent second connection pads is 70 μm.

In a second aspect, this application provides a fingerprint recognition apparatus, including any ultrasonic sensor described in the first aspect of this application.

In a third aspect, this application provides an electronic device, including the fingerprint recognition apparatus described in the second aspect of this application.

Through the ultrasonic sensor, the fingerprint recognition apparatus, and the electronic device provided above, the embodiments of the application provide a first chip disposed on a substrate and electrically connected to a piezoelectric transducer on same substrate, so that the TFT circuit on the substrate can be omitted, and the size of the ultrasonic sensor can be reduced, or a larger piezoelectric transducer can be provided under the same size of the substrate, while the electrical transmission path between the piezoelectric transducer and the first chip can be shortened, the signal to noise ratio of the sensing signal, the signal transmission quality, and therefore the ultrasonic sensor performance, can be improved, and the size of the sensor module can be reduced.

### BRIEF DESCRIPTION OF THE DRAWINGS

The above and other objectives, features and advantages of the exemplary implementations of this application will become readily apparent from the following detailed description, which proceeds with reference to the accompanying drawings. In the accompanying drawings, several implementations of this application are illustrated by way of example but not limitation, and like or corresponding reference numerals indicate like or corresponding parts, in which:

FIG. 1 shows a schematic diagram of a conventional ultrasonic sensing apparatus;

FIG. 2 shows a schematic diagram of an ultrasonic sensor according to some embodiments of this application;

FIG. 3 shows a schematic diagram of an ultrasonic sensor including a second chip according to an embodiment of this application;

FIG. 4A shows a schematic diagram of an ultrasonic sensor with a second chip disposed on a first connection plate according to some embodiments of this application;

FIG. 4B is a schematic diagram illustrating a use state of the ultrasonic sensor in FIG. 4A;

FIG. 5A is a schematic diagram of an ultrasonic sensor with a second chip disposed on a first connection plate according to other embodiments of this application;

FIG. 5B shows a schematic diagram of the ultrasonic sensor in FIG. 5A shown from a B direction view;

FIG. 6 shows a schematic side view of an ultrasonic sensor according to still other embodiments of this application;

FIG. 7 shows a schematic diagram of a piezoelectric transducer including strip-shaped electrodes according to an embodiment of this application;

FIG. 8A shows a schematic top view of an ultrasonic sensor with exposed connection pads according to some embodiments of this application;

FIG. 8B shows a schematic side view of the ultrasonic sensor in FIG. 8A; and

FIG. 8C shows a schematic diagram of an ultrasonic sensor with a first chip and a second chip mounted.

### DETAILED DESCRIPTION

The technical solutions in the embodiments of this application will be clearly and completely described below with reference to the accompanying drawings in the embodiments of this application. Apparently, the described embodiments are only part, but not all, of the embodiments of this application. All other embodiments, which can be derived by those skilled in the art from the embodiments of this application without making any creative effort, shall fall within the protection scope of this application.

It will be understood that the terms “comprise” and “include”, when used in the description and claims of this application, specify the presence of the stated features, integers, steps, operations, elements, and/or components, but do not preclude the presence or addition of one or more other features, integers, steps, operations, elements, components, and/or groups thereof.

It is also to be understood that the terminology used in the description of this application herein is for the purpose of describing particular embodiments only, and is not intended to be limiting of this application. As used in the specification and claims of this application, the singular forms “a”, “an” and “the” are intended to include the plural forms as well, unless the context clearly indicates otherwise. It should be further understood that the term “and/or” as used in the description and claims of this application refers to any and all possible combinations of one or more of the associated listed items and includes such combinations.

As used in this specification and claims, the term “if” may be interpreted as “when” or “once” or “in response to determining” or “in response to detecting” depending on the context. Similarly, the phrase “if it is determined” or “if [the described condition or event] is detected” may be interpreted contextually as meaning “upon determining” or “in response to determining” or “upon detecting [the described condition or event]” or “in response to detecting [the described condition or event]”.

Specific implementations of this application will be described in detail below with reference to the accompanying drawings.

FIG. 2 shows a schematic diagram of an ultrasonic sensor according to some embodiments of this application. As shown in FIG. 2, the ultrasonic sensor 200 may include: a substrate 210; a piezoelectric transducer 111 on the substrate 210; a first chip 221 on the substrate 210 and electrically connected to the piezoelectric transducer 111. The first chip 221 may include one type of a transmitter chip, a receiver chip, or an integrated chip, wherein the integrated chip integrates circuits of the transmitter chip and the receiver chip.

The substrate 210 is a bottom support structure of the ultrasonic sensor 200, and provides a base platform for mounting and fixing the piezoelectric transducer 111, the first chip 221, and other components. The substrate 210 may include at least one circuit trace layer to form electrical connections between components arranged on the substrate. In some embodiments, the substrate 210 may be a combination of one or more of a glass substrate, a ceramic substrate, a silicon substrate, or the like.

The piezoelectric transducer 111, which is disposed on the substrate 210, is a key component in the ultrasonic sensor for mutual conversion between electric energy and acoustic energy. Using characteristics of the piezoelectric material, the piezoelectric transducer 111 converts an electrical signal from the transmitter chip into an ultrasonic signal for further transmission, or converts the received ultrasonic signal into an electrical signal transmitted to the receiver chip. In some embodiments, types of piezoelectric transducers may include, but are not limited to, transducers composed of polyvinylidene fluoride (PVDF), polyvinylidene fluoride-trifluoroethylene copolymers (PVDF-TrFE), ceramic piezoelectric materials (such as AlN), or microelectromechanical structures (MEMSs).

As a core component for signal processing and control in the ultrasonic sensor 200, the first chip 221 is disposed on the substrate 210, and can be electrically connected to the piezoelectric transducer 111 by, for example, a lead, a circuit trace on the substrate, and the like. The first chip 221 may be one type of a transmitter chip, a receiver chip, or an integrated chip. The transmitter chip (Tx chip) has a main function of controlling and/or driving transmission of ultrasonic signals, and can generate electrical signals of specific frequency, amplitude and waveform, which can be converted into ultrasonic signals for further transmission by the piezoelectric transducer. The receiver chip (Rx chip) has a main function of receiving and processing ultrasonic signals sensed by the piezoelectric transducer, and can amplify, filter and perform other processing on weak electrical signals to extract useful information. The integrated chip is a chip which integrates a transmitter chip and a receiver chip, where the related transmitter and receiver circuit modules are integrated on the same chip through a semiconductor manufacturing process, to achieve a more compact design and more efficient signal processing.

In some embodiments, a ratio of an area of the piezoelectric transducer 111 to an area of a surface of the substrate where the piezoelectric transducer 111 is located is greater than 0.6. For example, the ratio of the area of the piezoelectric transducer 111 to the area of the surface of the substrate where the piezoelectric transducer 111 is located may be 0.61, 0.62, 0.65, 0.68, 0.7, 0.72, 0.75, 0.78, 0.8, 0.82, 0.85, 0.88, 0.9, or the like. In other embodiments, the ratio of the area of the piezoelectric transducer 111 to the area of the surface of the substrate where the piezoelectric transducer 111 is located is greater than 0.7. In still other embodiments, the ratio of the area of the piezoelectric transducer 111 to the area of the surface of the substrate where the piezoelectric transducer 111 is located is greater than 0.8.

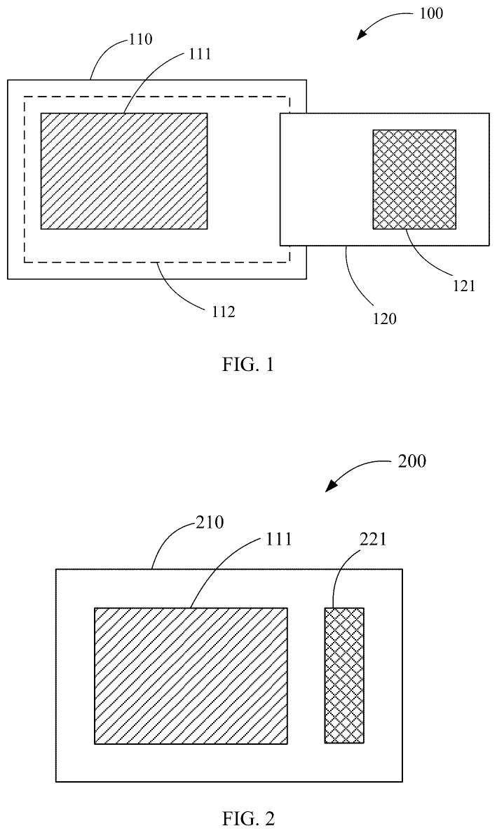

Compared with an ultrasonic sensing apparatus employing a TFT circuit (e.g., as shown in FIG. 1), the ultrasonic sensor of this embodiment significantly increases the fill factor. In the ultrasonic sensor, a larger fill factor means that an effective sensing area of the piezoelectric transducer 111 occupies a larger proportion of the substrate 210, which can improve the utilization rate of the substrate, and thus reduce the cost. Meanwhile, ultrasonic signals can be transmitted and received more effectively, so that the capture capability and detection sensitivity of the sensor to ultrasonic signals are improved. This is important for improving the performance of the ultrasonic sensor, especially in high resolution and high accuracy applications such as ultrasonic fingerprint recognition.

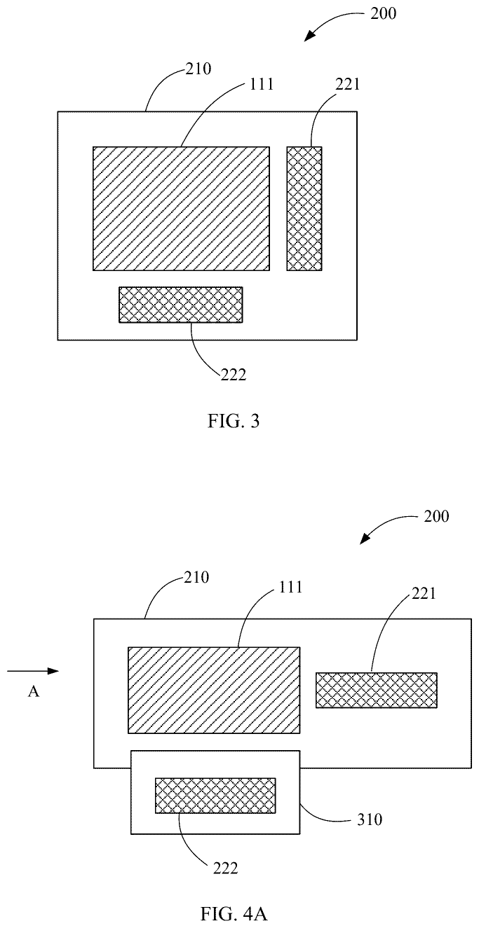

The ultrasonic sensor provided in the embodiments of this application is exemplarily described above with reference to FIG. 2, and it will be appreciated that by disposing the first chip electrically connected to the piezoelectric transducer on the substrate, the signal transmission path is shortened, so that the signal loss and interference caused by long distance transmission are reduced, and the signal quality and transmission efficiency are improved, thereby effectively improving the performance of the ultrasonic sensor. Meanwhile, since the chips related to the transmitting and/or receiving functions are directly integrated on the substrate without a conventional TFT manufacture procedure, the limitations such as a big TFT circuit area, a low operation frequency, a low processing speed, and the like can be avoided, a smaller sensor can be obtained, and the fill factor (a ratio of a sensing area to a sensor size) can be increased, so that the ultrasonic sensor provided in the embodiments of this application can be applied to devices of high-frequency applications. For example, higher ultrasonic energy can be obtained by beam forming to increase the signal-to-noise ratio of a device. In addition, this configuration provides flexibility in allowing the selection of the transmitter, receiver or integrated chips according to the specific application requirements, thereby optimizing the manufacturing process and the cost control. It will also be appreciated that the ultrasonic sensor shown in FIG. 2 is exemplary and not limiting, and for example, the substrate may not be limited to being provided with only one chip type, but may be provided with more chip types, as will be further explained below in conjunction with FIG. 3.

FIG. 3 shows a schematic diagram of an ultrasonic sensor including a second chip according to an embodiment of this application. As shown in FIG. 3, the ultrasonic sensor 200 may include a substrate 210, a piezoelectric transducer 111, a first chip 221, and a second chip 222. The piezoelectric transducer 111, the first chip 221, and the second chip 222 are all disposed on the substrate 210. The second chip 222 includes one type of the transmitter chip or the receiver chip, and the first chip 221 includes the other type of the transmitter chip or the receiver chip.

In some embodiments, at least one of the first chip 221 or the second chip 222 may be disposed on the substrate at a side edge of the piezoelectric transducer 111. In other embodiments, the first chip 221 and the second chip 222 are disposed on the substrate on the same side of the piezoelectric transducer 111, or on the substrate at two sides of the piezoelectric transducer 111, respectively.

For example, as shown in FIG. 3, the first chip 221 and the second chip 222 may be disposed on the substrate 210 at two sides of the piezoelectric transducer 111, respectively. The piezoelectric transducer 111, the first chip 221 and the second chip 222 may be disposed on the same side of the substrate 210, and the first chip 221 and the second chip 222 are electrically connected to the piezoelectric transducer 111 through circuit traces or lead connections on the substrate 210, respectively, thereby implementing effective transmission and interaction of signals.

In some embodiments, the first chip 221 may be a transmitter chip, and the second chip 222 may be a receiver chip. In other embodiments, the first chip 221 may be a receiver chip, and the second chip 222 may be a transmitter chip. The first chip 221 and the second chip 222 perform transmitting and receiving functions, respectively, and cooperate to implement joint control and processing of ultrasonic signals.

By providing two independent chips, i.e., the first chip and the second chip, their respective functions can be optimized and designed separately. For example, the transmitter chip may focus on efficient signal emission, and may adopt a high-voltage chip manufacture procedure to enhance the transmission capability; while the receiver chip may focus on the receiving and processing of weak signals, and may adopt a low-voltage chip manufacture procedure to reduce the power consumption and improve the sensitivity. In this manner, the advantages of each chip can be fully exerted, thereby improving the overall performance. Compared with an integrated chip which is limited by a single manufacture procedure (a high-voltage chip manufacture procedure), the transmitting and receiving functions are embodied on two independent chips, and the manufacturing process most suitable for each function can be selected, which can help to reduce the manufacturing cost, reduce the electromagnetic interference and signal crosstalk between the two chips, and improve the signal accuracy and stability. In addition, the independent chips can disperse heat, which can help to improve the stability and service life of the chips, and allow flexible layouts according to actual requirements to meet different design requirements and space limitations.

In some embodiments, the first chip 221 and the second chip 222 may be disposed on opposite sides of the piezoelectric transducer 111 to form a symmetrical layout. In other embodiments, the first chip 221 and the second chip 222 may be disposed on two adjacent sides of the piezoelectric transducer 111 (as shown in FIG. 3). The first chip 221 and the second chip 222 may each have a strip shape as shown in FIG. 3, for example, or may have other shapes as needed.

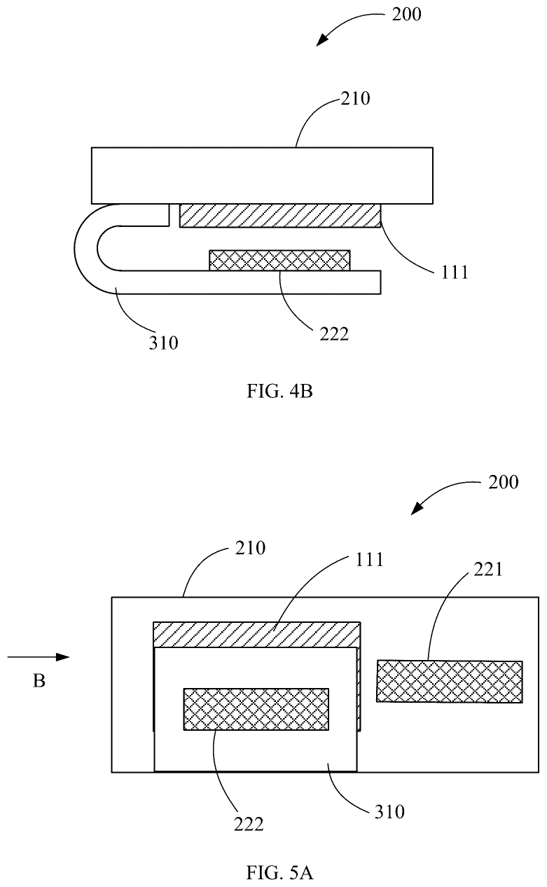

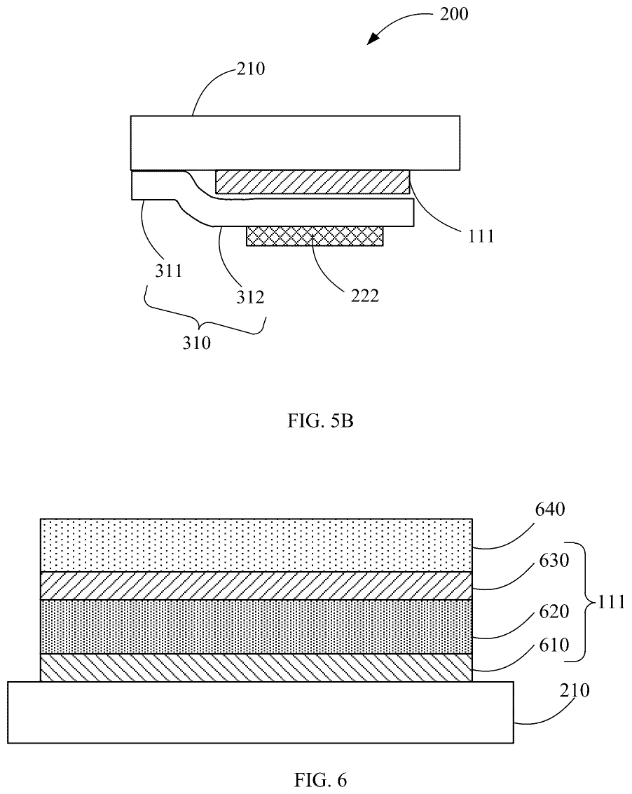

The ultrasonic sensor with two chips on the substrate provided in the embodiments of this application is exemplarily introduced above with reference to FIG. 3, and it will be appreciated that by directly disposing the first chip 221 and the second chip 222 near the piezoelectric transducer 111 on substrate 210, and on different sides of the piezoelectric transducer 111, the piezoelectric transducer 111 is close to both the receiver chip and the transmitter chip, and the transmission line path is shortened, which can help to reduce the influence of parasitic capacitance on signals and the driving energy, reduce the driving current and signal transmission loss, and reduce the overall power consumption of the product while improving the performance of the product. It will be further appreciated that the ultrasonic sensor shown in FIG. 3 is exemplary, and for example, the first chip and the second chip may not be limited to being disposed on the substrate at two sides of the piezoelectric transducer, but may be disposed on the substrate on the same side of the piezoelectric transducer. For another example, the second chip may not be limited to being disposed on the substrate, and may be disposed on the first connection plate as needed, as will be exemplarily described below in conjunction with FIGS. 4A to 5B.

FIG. 4A shows a schematic diagram of an ultrasonic sensor with a second chip disposed on a first connection plate according to some embodiments of this application. FIG. 4B is a schematic diagram illustrating a use state of the ultrasonic sensor in FIG. 4A. As shown in FIGS. 4A and 4B, the ultrasonic sensor 200 may include a substrate 210, a piezoelectric transducer 111 and a first chip 221 on the substrate 210, and further a first connection plate 310, and a second chip 222 on the first connection plate 310. The first connection plate 310 is connected to the substrate 210, the second chip 222 includes one type of the transmitter chip or the receiver chip, and the first chip 221 includes the other type of the transmitter chip or the receiver chip.

In this embodiment, the first connection plate 310 is connected to the substrate 210 to function as a bridge and provide a mounting position for the second chip 222. The second chip 222 is disposed on the first connection plate 310, and performs one of the transmitting or receiving function, while the first chip 221 performs the other function. Specifically, if the second chip 222 is a transmitter chip, the first chip 221 is a receiver chip, and vice versa, and will not be described in detail here. Such a structural design enables the substrate 210 to be further reduced in size, and allows those skilled in the art to flexibly configure the positions and functions of the chips according to the actual requirements on the ultrasonic sensor, thereby optimizing the spatial layout inside the sensor and improving the overall performance and applicability of the sensor.

In some embodiments, the first connection plate 310 may include a flexible circuit board. In other embodiments, the first connection plate 310 may be connected to the substrate 210 by bonding, welding, clipping, and the like. In still other embodiments, the first connection plate 310 may be connected to the substrate 210 by ACF bonding. ACF bonding is a process for implementing electronic component connection by an anisotropic conductive film (ACF), which realizes the electrical connection between the first connection plate and the substrate mainly by using the ACF to arrange conductive particles in an adhesive film at high temperature and high pressure to form conductive channels, and after the ACF is cured, the ACF is kept insulated in a planar direction (i.e., a direction parallel to the connection surface) to avoid a short circuit. Compared with the conventional welding process, ACF bonding has the advantages of fine pitch and high reliability, and can realize a higher integration level and a smaller packaging size, thereby satisfying the development trend of lightweight, short and small modern electronic products.

In other embodiments, the second chip 222 may be disposed on the first connection plate by a surface mount technology (SMT). In still other embodiments, the second chip 222 and the substrate 210 may be connected to different surfaces of the first connection plate 310 (as shown in FIG. 4A), respectively. In other words, a connection between the substrate 210 and the first connection plate 310 and a connection between the second chip 222 and the first connection plate 310 are located on two surfaces of the first connection plate 310, respectively. In other embodiments, the second chip 222 and the substrate 210 may be connected to the same surface of the first connection plate 310. In other words, a connection between the substrate 210 and the first connection plate 310 and a connection between the second chip 222 and the first connection plate 310 may be located on the same surface of the first connection plate 310.

In one use state of the ultrasonic sensor shown in FIG. 4A, the first connection plate 310 may be bent toward the piezoelectric transducer 111. FIG. 4B shows a view from an A direction view when the first connection plate 310 of FIG. 4A is bent. As shown in FIG. 4B, when the first connection plate 310 is bent toward the piezoelectric transducer 111, the second chip 222 may be located on a side of the first connection plate 310 facing the piezoelectric transducer 111. In other embodiments, the second chip 222 may not be limited to being located on a side of the first connection plate 310 facing the piezoelectric transducer 111, and may also be located on the other side of the first connection plate 310 facing away from the piezoelectric transducer 111.

FIG. 5A is a schematic diagram of an ultrasonic sensor with a second chip disposed on a first connection plate according to other embodiments of this application. FIG. 5B shows a schematic diagram of the ultrasonic sensor in FIG. 5A shown from a B direction view. As shown in FIGS. 5A and 5B, the ultrasonic sensor 200 may include a substrate 210, a piezoelectric transducer 111 and a first chip 221 on the substrate 210, and further a first connection plate 310, and a second chip 222 on the first connection plate 310. The first connection plate 310 is connected to the substrate 210, the second chip 222 includes one type of the transmitter chip or the receiver chip, and the first chip 221 includes the other type of the transmitter chip or the receiver chip.

Unlike the ultrasonic sensor shown in FIGS. 4A and 4B, in the ultrasonic sensor shown in FIGS. 5A and 5B, the first connection plate 310 may include a connection part 311 and an extension part 312. The connection part 311 is connected to the substrate 210, the extension part 312 is connected to the connection part 311, and the second chip 222 is disposed on the extension part 312. The extension part 312 may extend toward the piezoelectric transducer 111. In some embodiments, as shown in FIG. 5B, the second chip 222 may be disposed on a side of the extension part 312 facing away from the piezoelectric transducer 111. In other embodiments, the second chip 222 may not be limited to being disposed on a side of the extension part 312 facing away from the piezoelectric transducer 111, and may be disposed on a side of the extension part 312 facing the piezoelectric transducer 111.

With the arrangement shown in FIGS. 4A to 5B, when the substrate space is insufficient, the second chip may be disposed on the first connection plate and connected to the substrate through the first connection plate, thereby effectively solving the problem of the limited substrate space. With the arrangement shown in FIGS. 4B to 5B, a small-width design of the ultrasonic sensor can be realized, and the requirements of a specific product application, such as a fingerprint application at a side edge of an electronic device, are satisfied.

The chip layout in the ultrasonic sensor according to the embodiments of this application has been described in detail above with reference to FIGS. 2 to 5B, and the piezoelectric transducer in the ultrasonic sensor will be described in detail below with reference to FIG. 6.

FIG. 6 shows a schematic side view of an ultrasonic sensor according to still other embodiments of this application. As shown in FIG. 6, in the embodiments of this application, the piezoelectric transducer 111 in the ultrasonic sensor may have a multi-layer structure including a lower electrode layer 610, a piezoelectric material layer 620, and an upper electrode layer 630. The piezoelectric material layer 620 is located between the lower electrode layer 610 and the upper electrode layer 630, and the lower electrode layer 610 is located between the substrate 210 and the piezoelectric material layer 620. The upper electrode layer 610 and the lower electrode layer 630 are conductive layers of the piezoelectric transducer 111. One of the upper electrode layer 630 or the lower electrode layer 610 is configured to be electrically connected to a receiver chip (not shown in FIG. 6), and the other is configured to be electrically connected to a transmitter chip (not shown in FIG. 6). This structure enables the piezoelectric transducer 111 to apply a voltage or collect signals through the upper electrode layer 630 and the lower electrode layer 610, thereby implementing the conversion between electric energy and acoustic energy.

In some embodiments, the lower electrode layer 610 has a thickness of 0.3 μm to 1.5 μm. Illustratively, the thickness of the lower electrode layer 610 may be 0.3 μm, 0.4 μm, 0.5 μm, 0.6 μm, 0.7 μm, 0.8 μm, 0.9 μm, 1.0 μm, 1.1 μm, 1.2 μm, 1.3 μm, 1.4 μm, 1.5 μm, or the like, or any other value in the range of 0.3 μm to 1.5 μm.

In some embodiments, the upper electrode layer 630 has a thickness of 0.3 μm to 1.5 μm. Illustratively, the thickness of the upper electrode layer 630 may be 0.3 μm, 0.4 μm, 0.5 μm, 0.6 μm, 0.7 μm, 0.8 μm, 0.9 μm, 1.0 μm, 1.1 μm, 1.2 μm, 1.3 μm, 1.4 μm, 1.5 μm, or the like, or any other value in the range of 0.3 μm to 1.5 μm.

In still other embodiments, the piezoelectric material layer 620 has a thickness of 5 μm to 30 μm. Illustratively, the thickness of the piezoelectric material 620 may be 5 μm, 6 μm, 7 μm, 8 μm, 9 μm, 10 μm, 11 μm, 12 μm, 13 μm, 14 μm, 15μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, or the like, or any other value in the range of 5 μm to 30 μm. In some embodiments, the piezoelectric material layer 620 may include one or more of a polyvinylidene fluoride (PVDF) layer, and a polyvinylidene fluoride-trifluoroethylene copolymer (PVDF-TrFE) layer.

In other embodiments, the ultrasonic sensor may further include a protective layer 640 covering at least the upper electrode layer 630. In other embodiments, the protective layer 640 has a thickness of 3 μm to 40 μm. Illustratively, the thickness of the protective layer 640 may be 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, or the like, or any other value in the range of 3 μm to 40 μm. In still other embodiments, the protective layer 640 has a thickness of 3 μm to 20 μm. In some embodiments, the protective layer 640 has a thickness of 12 μm to 36 μm. In other embodiments, the protective layer 640 has a thickness of 12 μm to 30 μm.

Different thicknesses of the protective layer are suitable for different application scenarios and manufacturing process requirements. The selection of the thickness of the protective layer may be determined according to a resonance frequency of the piezoelectric transducer 111. Specifically, different materials (such as an OLED or a metal) have different propagation and attenuation characteristics for ultrasonic signals, and by selecting an appropriate resonance frequency according to the application scenario and an appropriate protective layer thickness according to the resonance frequency, it may help to improve the performance and signal quality of the ultrasonic sensor.

For example, in some scenarios, the resonance frequency may be in a range of 15 MHz to 30 MHz, or 15 MHz to 25 MHz, for an ultrasonic sensor located below an organic light-emitting diode (OLED). In other scenarios, the resonance frequency is typically higher than 30 MHz for an ultrasonic sensor located below a metal. Generally, the higher the resonance frequency is desired, the thinner the protective layer thickness is selected.

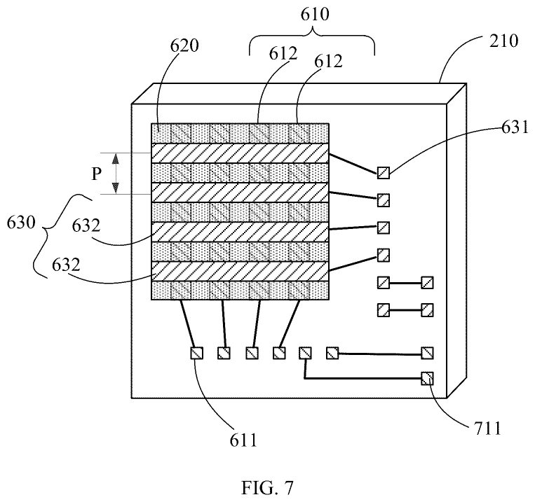

The piezoelectric transducer having a multi-layer structure has been exemplarily described above in conjunction with FIG. 6, and a specific implementation of the piezoelectric transducer will be further described below in conjunction with FIG. 7.

FIG. 7 shows a schematic diagram of a piezoelectric transducer including strip-shaped electrodes according to an embodiment of this application. As shown in FIG. 7, the piezoelectric transducer on the substrate 210 includes an upper electrode layer 630, a piezoelectric material layer 620, and a lower electrode layer 610. The lower electrode layer 610 may include a plurality of strip-shaped lower electrodes 612 distributed in parallel, where each lower electrode 612 leads out a corresponding first connection pad 611. The upper electrode layer 630 may include a plurality of strip-shaped upper electrodes 632 distributed in parallel, where each upper electrode leads out a corresponding second connection pad 631. The plurality of lower electrodes 612 in the lower electrode layer 610 and the plurality of upper electrodes 632 in the upper electrode layer 630 are orthogonally arranged.

The first connection pad 611 is disposed on the substrate 210, and configured to connect the lower electrode layer 610 to an external circuit (e.g., the first chip or the second chip). The first connection pad 611 may be electrically connected to the corresponding lower electrode 612 by, for example, a lead or a circuit trace on the substrate 210. The second connection pad 631 is disposed on the substrate 210, and configured to connect the upper electrode layer 630 to an external circuit (e.g., the first chip or the second chip). The second connection pad 631 may be electrically connected to the corresponding upper electrode 632 by, for example, a lead or a circuit trace on the substrate 210. In some embodiments, the first connection pad 611 and/or the second connection pad 631 may be implemented by forming a metalized region on the substrate 210, or by providing a pad on the substrate 210.

The plurality of lower electrodes 612 in the lower electrode layer 610 and the plurality of upper electrodes 632 in the upper electrode layer 630 are orthogonally arranged, which means that the plurality of lower electrodes 612 are perpendicular to the plurality of upper electrodes 632. The upper electrodes and lower electrodes orthogonally arranged can reduce mutual interference between the electrodes, improve the transmission efficiency and quality of signals, and thereby improve the performance of the ultrasonic sensor.

In some embodiments, each upper electrode 632 has a width of 30 μm to 150 μm. Illustratively, the width of each upper electrode 632 may be 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, or the like, or any other value in the range of 30 μm to 150 μm.

In other embodiments, a physical pitch P between two adjacent upper electrodes 632 is 50 μm to 200 μm. Illustratively, the physical pitch P between two adjacent upper electrodes 632 may be 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, or the like, or any other value in the range of 50 μm to 200 μm.

The physical pitch P is a center-to-center distance of the two adjacent lower electrodes. Taking FIG. 7 as an example, the physical pitch P between two adjacent upper electrodes 632 is a distance between center lines in an extending direction (or a length direction) of the two adjacent upper electrodes 632. Based on the physical pitch P between two adjacent upper electrodes 632 and the width of each upper electrode 632, a gap distance between two adjacent upper electrodes 632 can be determined.

In still other embodiments, each lower electrode 612 has a width of 30 μm to 150 μm. Illustratively, the width of each lower electrode 612 may be 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, or the like, or any other value in the range of 30 μm to 150 μm. The width of the lower electrode 612 may be the same as, or different from, the width of the upper electrode 632, which may be set as needed.

In some embodiments, a physical pitch P between two adjacent lower electrodes 612 is 50 μm to 200 μm. Illustratively, the physical pitch P between two adjacent lower electrodes 612 may be 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, or the like, or any other value in the range of 50 μm to 200 μm. The physical pitch between two adjacent upper electrodes may be the same as, or different from, the physical pitch between two adjacent lower electrodes, which may be set according to the requirements of the application scenario.

In the design of the piezoelectric transducer, the number and layout of electrodes will directly affect the performance of the piezoelectric transducer. By limiting the physical pitch between two adjacent upper electrodes and the physical pitch between two adjacent lower electrodes within the range of 50 μm to 200 μm, a more compact layout of the electrodes can be obtained, which allows more electrodes to be integrated on the same substrate area, and can realize a higher resolution or a higher signal acquisition density, thereby improving the performance and functionality of the piezoelectric transducer. In addition, a proper physical pitch can reduce mutual interference between electrodes, such as parasitic capacitance and crosstalk, thereby improving the accuracy and stability of signal transmission, and enhancing the performance of the ultrasonic sensor. For example, in high-frequency applications, the mutual interference between electrodes may significantly affect the quality of signals, and by precisely controlling the physical pitch between adjacent electrodes, such interference can be effectively reduced, and the integrity and reliability of signals can be guaranteed.

In still other embodiments, a plurality of first connection pads 611 may be linearly arranged, and a physical pitch between two adjacent first connection pads 611 may be 70 μm; and a plurality of second connection pads 631 may be linearly arranged, and a physical pitch between two adjacent second connection pads 631 may be 70 μm. By “linearly arranged”, it refers to being arranged along a straight line. The physical pitch between two adjacent first connection pads 611 may be a distance between center points of the two adjacent first connection pads 611. Similarly, the physical pitch between two adjacent second connection pads 631 may be a distance between center points of the two adjacent second connection pads 631.

In other embodiments, the physical pitch between two adjacent lower electrodes 612 may be greater than or equal to the physical pitch between two adjacent first connection pads 611; and the physical pitch between two adjacent upper electrodes 632 may be greater than or equal to the physical pitch between two adjacent second connection pads 631. The physical pitch between two adjacent lower electrodes 612 is greater than the physical pitch between two adjacent first connection pads 611, forming a finger electrode structure, which can enable a more compact arrangement of the plurality of first connection pads 611, and save the space occupied on the substrate 210. The physical pitch between two adjacent upper electrodes 632 is greater than the physical pitch between two adjacent second connection pads 631, forming a finger electrode structure, which can enable a more compact arrangement of the plurality of second connection pads 631, and save the space occupied on the substrate 210.

In still other embodiments, the substrate 210 may be further provided with an output connection pad 711 serving as an electrical interface between the piezoelectric transducer and an external system, so that an electrical signal generated by the piezoelectric transducer can be transmitted to the external system, or an electrical signal from the external system can be transmitted to the piezoelectric transducer. The output connection pad 711 may be implemented by forming a metalized region on the substrate 210, or by providing a pad on the substrate 210. Meanwhile, the output connection pad 711 may be electrically connected to the first pad 611 and the second pad 631 by a lead or a circuit trace on the substrate 210. In other embodiments, the number of first connection pads 611 may be greater than the number of the lower electrodes 612, to electrically connect the output connection pad 711; and the number of second connection pads 631 may be greater than the number of the upper electrodes 632, to electrically connect the output connection pad 711.

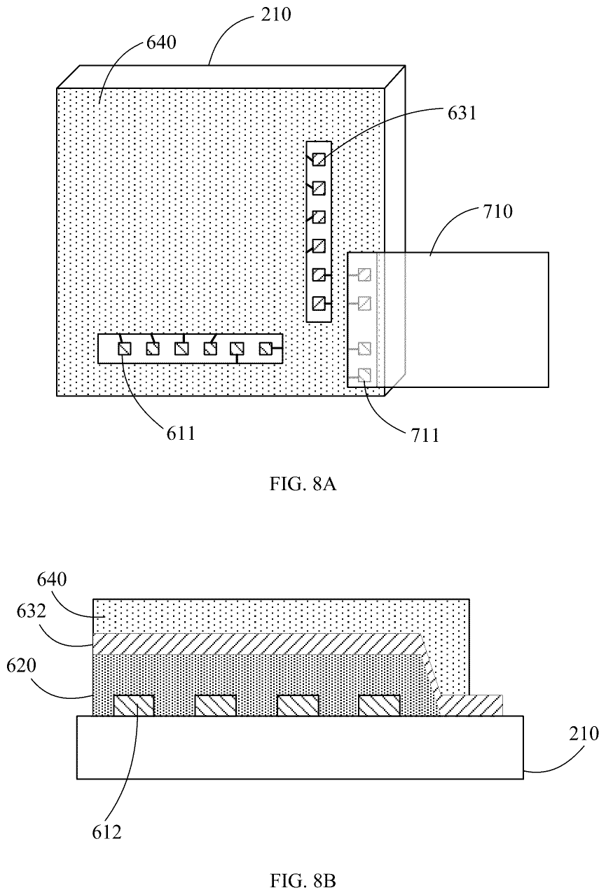

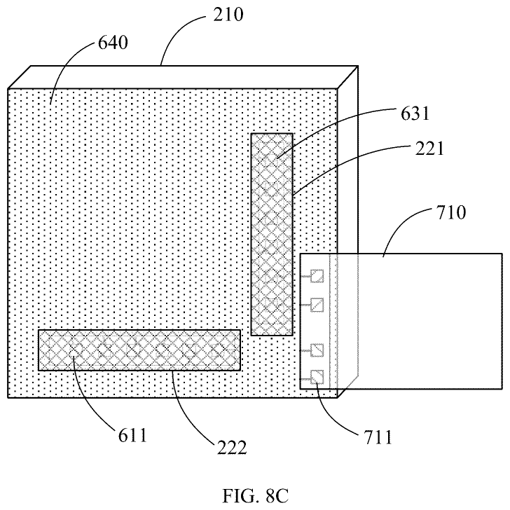

While one implementation of the piezoelectric transducer on the substrate is exemplarily described above with reference to FIG. 7, it will be appreciated that the structure shown in FIG. 7 is exemplary and not limiting. For example, the number of upper electrodes 632 and the number of lower electrodes 612 may not be limited to four as shown in the figures, and may be larger or smaller as needed. For another example, the first connection pad 611 and the second connection pad 631 may not be limited to being disposed on two adjacent sides of the piezoelectric transducer respectively as shown, and may be disposed on two opposite sides of the piezoelectric transducer, or on the same side of the piezoelectric transducer as needed. When the first connection pad and the second connection pad are disposed on two opposite sides of the piezoelectric transducer, the substrate 210 may be set to a strip shape to reduce the width of the substrate, thereby being adapted to an application scenario such as a side edge of an electronic device (e.g., a mobile phone). In some embodiments, the first connection pad and the second connection pad may be used to connect the integrated chip when disposed on the same side of the piezoelectric transducer. The above introduces an implementation of the piezoelectric transducer, and an ultrasonic sensor including a protective layer will be further described below with reference to FIGS. 8a to 8c.

FIG. 8A shows a schematic top view of an ultrasonic sensor with exposed connection pads according to some embodiments of this application. FIG. 8B shows a schematic side view of the ultrasonic sensor in FIG. 8A. In contrast to the ultrasonic sensor shown in FIG. 7, FIGS. 8A and 8B show a case where the upper electrode layer 630 and a surface of the substrate are covered with a protective layer 640. As shown in FIGS. 8A and 8B, the protective layer 640 may cover the upper electrode layer and a surface of the substrate where the piezoelectric transducer is located, and expose the first connection pad 611 led out from the lower electrode layer and the second connection pad 631 led out from the upper electrode layer.

The protective layer 640 may cover the upper electrode layer and a surface of the substrate where the piezoelectric transducer is located, to form a protective structure layer that can prevent the piezoelectric transducer from being damaged or interfered, while only exposing necessary connection pads on the substrate 210 for electrical connection, thereby protecting the conductive paths and other components on the substrate 210. In some embodiments, the first connection pad 611 exposed from the protective layer 640 may be electrically connected to one type of the transmitter chip or the receiver chip, and the exposed second connection pad 631 may be electrically connected to the other type of the transmitter chip or the receiver chip. In other embodiments, the exposed first connection pad 611 and second connection pad 631 may be electrically connected to the integrated chip.

In some embodiments, the ultrasonic sensor 200 may further include a second connection plate 710 for connecting an external system. The second connection plate 710 is connected to the substrate 210, and the number of output connection pads 711 on the substrate 210 for connecting the second connection plate 710 is smaller than the number of first connection pads 611 and/or second connection pads 631. The output connection pad 711 is exposed from the protective layer 640 to be connected to the second connection plate 710.

The second connection plate 710 may be a circuit board configured to connect the ultrasonic sensor with an external system (e.g., a CPU, a host, or other devices), to enable an electrical connection and signal transmission between the sensor and the external system. In other embodiments, the second connection plate 710 may be a flexible circuit board or a printed circuit board.

It will be appreciated that in the conventional technology, the transmitter chip and the receiver chip are disposed on the second connection plate, and the number of output connection pads desired is at least equal to the sum of the number of first connection pads and the number of second connection pads, so that signal transmission between the piezoelectric transducer and the transmitter chip, and between the piezoelectric transducer and the receiver chip, can be implemented. In contrast, in the ultrasonic sensor provided in the embodiments of this application, since at least the first chip is disposed on the substrate 210 (i.e., disposed on the substrate 210 through the first connection pad 611 and/or the second connection pad 631), the number of output connection pads 711 may be smaller than the number of first connection pads 611 and/or second connection pads 631, so that the number of output connection pads required for connecting the substrate to the second connection plate 710 can be greatly reduced. Meanwhile, since the width of second connection plate should be adapted to a size of the region with the output connection pads, the ultrasonic sensor scheme provided in the embodiments of this application can, compared with the conventional technology, effectively reduce the size of second connection plate, further reduce the manufacturing cost of the second connection plate, and satisfy the miniaturization development requirement of sensors.

In some embodiments, the ultrasonic sensor shown in FIGS. 8A and 8B may be implemented, for example, by the following method: First, a first metal layer (e.g., copper, aluminum or gold) may be deposited on the substrate 210 by a physical vapor deposition (PVD) process or a plating process, and then patterned by exposure, development, and the other steps to form a finger electrode structure of the lower electrode 612 and a wire pattern connected to the first connection pad (i.e., a circuit structure between the first connection pad and the output connection pad). Next, a piezoelectric material layer 620 may be formed on the lower electrode 612 through a coating or screen printing process. Then, a second metal layer (e.g., copper, aluminum or gold) is formed on the piezoelectric material layer 620 by a PVD or plating process, which is also patterned by exposure, development and other steps to form a finger electrode structure of the upper electrode 632 and a wire pattern connected to the second connection pad (i.e., a circuit structure between the second connection pad and the output connection pad). Then, a protective layer 640, with photoresist or ink as a main material, is formed on a surface of the substrate 210 through a coating or screen printing process, and patterned by exposure, development or a stencil process to expose the first connection pad, the second connection pad, and the output connection pad.

Finally, the first chip, the second chip and the second connection plate are connected to corresponding positions of the substrate 210 by an anisotropic conductive film (ACF), to obtain the ultrasonic sensor shown in FIG. 8C, for example. FIG. 8C shows a schematic diagram of an ultrasonic sensor with a first chip 221 and a second chip 222 mounted. As shown in FIG. 8C, the first chip 221 may be electrically connected to the second connection pad 631 exposed from the protective layer 640, and the second chip 222 may be electrically connected to the first connection pad 611 exposed from the protective layer 640. In other embodiments, the first chip 221 may be electrically connected to the first connection pad 611, and the second chip 222 may be electrically connected to the second connection pad 631.

While the ultrasonic sensor including a protective layer according to some embodiments of this application has been exemplarily described above with reference to FIGS. 8A to 8C, it will be appreciated that the above description is exemplary and not limiting. For example, the first connection pad and the second connection pad may not be limited to both being disposed on the substrate as illustrated, and in other embodiments, when the ultrasonic sensor further includes the first connection plate, the first connection pad or the second connection pad may be disposed on the first connection plate to be electrically connected to the second chip on the second connection plate.

To sum up, the application provides an ultrasonic sensor which, by providing at least the first chip on the substrate and electrically connected to the piezoelectric transducer also disposed on the substrate, favorably shorten the transmission path between piezoelectric transducer and the first chip, improve the signal processing performance of the ultrasonic sensor, and help to reduce the size of the ultrasonic sensor to satisfy the development requirement for lightweight ultrasonic sensors.

In a second aspect, this application provides a fingerprint recognition apparatus, which may include the ultrasonic sensor described in conjunction with any one of FIGS. 2 to 8C. The ultrasonic sensor provided in the embodiments of this application possesses multiple advantages, like small size, high fill factor, lower consumption and outstanding performance (for example, it can effectively reduce the signal transmission loss, improve the SNR, and the like), which enable its outstanding performance in fingerprint recognition applications, and can realize the fingerprint recognition function with high accuracy and high reliability. Therefore, the fingerprint recognition apparatus provided in the embodiments of this application has a prosper application prospect in all kinds of devices with a requirement for a fingerprint recognition function.

In a third aspect, this application further provides an electronic device, including the fingerprint recognition apparatus described in the second aspect of this application. By adopting the fingerprint recognition apparatus provided in the embodiments of this application, the electronic device can implement quick, accurate and safe user identification and verification functions. Therefore, the safety and user experience of the electronic device are improved, while the functions and application scenarios of the electronic device are expanded. For example, the electronic device can implement various safety-related operations, such as unlocking, payment verification, data protection and the like, by means of the fingerprint recognition function, and satisfy the requirements of users in different scenarios, such as a smartphone, a tablet, a laptop, a smart home device, a security device, and the like. Further, the fingerprint recognition apparatus provided in the embodiments of this application may be applied to different position requirements of the electronic device. For example, the ultrasonic sensor described in conjunction with any one of FIGS. 2 to 8C can satisfy the requirement of disposing the fingerprint recognition apparatus under a screen or backplane of the electronic device, or the ultrasonic sensor described in conjunction with any one of FIGS. 4B to 5B can satisfy the requirement of disposing the fingerprint recognition apparatus under a side edge of the electronic device.

Although various embodiments of this application have been shown and described herein, it will be obvious to those skilled in the art that such embodiments are provided by way of example only. Numerous modifications, changes, and substitutions may occur to those skilled in the art without departing from the spirit and scope of this application. It should be understood that various alternatives to the embodiments of this application described herein may be employed while practicing this application. It is intended that the following claims define the scope of this application and that equivalents or alternatives within the scope of these claims are covered thereby.

What is claimed is:

1. An ultrasonic sensor comprising:
a substrate;
a piezoelectric transducer on the substrate;
a first chip on the substrate and electrically connected to the piezoelectric transducer, the first chip including one type of a transmitter chip, a receiver chip, or an integrated chip, wherein the integrated chip integrates circuits of the transmitter chip and the receiver chip.

2. The ultrasonic sensor of claim 1, wherein the ultrasonic sensor further comprises a second chip, wherein the second chip includes one type of the transmitter chip or the receiver chip, while the first chip includes the other type of the transmitter chip or the receiver chip; and
at least one of the first chip or the second chip is disposed on the substrate at a side edge of the piezoelectric transducer.

3. The ultrasonic sensor of claim 2, wherein the first chip and the second chip are disposed on the substrate on the same side of the piezoelectric transducer, or on the substrate at two sides of the piezoelectric transducer, respectively.

4. The ultrasonic sensor of claim 2, wherein the ultrasonic sensor further comprises:
a first connection plate connected to the substrate; and
the second chip is disposed on the first connection plate.

5. The ultrasonic sensor of claim 4, wherein the first connection plate includes a connection part and an extension part, wherein the connection part is connected to the substrate, the extension part is connected to the connection part, and the second chip is disposed on the extension part.

6. The ultrasonic sensor of claim 1, wherein a ratio of an area of the piezoelectric transducer to an area of a surface of the substrate where the piezoelectric transducer is located is greater than 0.6.

7. The ultrasonic sensor of claim 1, wherein the piezoelectric transducer includes a lower electrode layer, a piezoelectric material layer, and an upper electrode layer, wherein the piezoelectric material layer is located between the lower electrode layer and the upper electrode layer, and the lower electrode layer is located between the substrate and the piezoelectric material layer; and
the ultrasonic sensor further includes a protective layer, wherein the protective layer covers the upper electrode layer and a surface of the substrate where the piezoelectric transducer is located, and exposes a first connection pad led out from the lower electrode layer and a second connection pad led out from the upper electrode layer.

8. The ultrasonic sensor of claim 7, wherein the exposed first connection pad is electrically connected to one type of the transmitter chip or the receiver chip, and the exposed second connection pad is electrically connected to the other type of the transmitter chip or the receiver chip; or
the exposed first and second connection pads are electrically connected to the integrated chip.

9. The ultrasonic sensor of claim 7, wherein the ultrasonic sensor further comprises a second connection plate for connecting an external system, wherein the second connection plate is connected to the substrate, and the number of output connection pads on the substrate for connecting the second connection plate is smaller than the number of first connection pads and/or second connection pads.

10. The ultrasonic sensor of claim 7, wherein the lower electrode layer includes a plurality of strip-shaped lower electrodes distributed in parallel, wherein each lower electrode leads out a corresponding first connection pad;
the upper electrode layer includes a plurality of strip-shaped upper electrodes distributed in parallel, wherein each upper electrode leads out a corresponding second connection pad; and
the plurality of lower electrodes in the lower electrode layer and the plurality of upper electrodes in the upper electrode layer are orthogonally arranged.

11. The ultrasonic sensor of claim 10, wherein each lower electrode has a width of 30 μm to 150 μm; and
a physical pitch between two adjacent lower electrodes is 50 μm to 200 μm, wherein the physical pitch is a center-to-center distance of the two adjacent lower electrodes.

12. The ultrasonic sensor of claim 10, wherein each upper electrode has a width of 30 μm to 150 μm; and
a physical pitch between two adjacent upper electrodes is 50 μm to 200 μm.

13. The ultrasonic sensor of claim 7, wherein the lower electrode layer has a thickness of 0.3 μm to 1.5 μm.

14. The ultrasonic sensor of claim 7, wherein the piezoelectric material layer has a thickness of 5 μm to 30 μm.

15. The ultrasonic sensor of claim 7, wherein the upper electrode layer has a thickness of 0.3 μm to 1.5 μm.

16. The ultrasonic sensor of claim 7, wherein the protective layer has a thickness of 3 μm to 40 μm; or
the protective layer has a thickness of 3 μm to 20 μm; or
the protective layer has a thickness of 12 μm to 36 μm; or
the protective layer has a thickness of 12 μm to 30 μm.

17. The ultrasonic sensor of claim 10, wherein a plurality of first connection pads are linearly arranged, and a physical pitch between two adjacent first connection pads is 70 μm; and
a plurality of second connection pads are linearly arranged, and a physical pitch between two adjacent second connection pads is 70 μm.

18. A fingerprint recognition apparatus, comprising an ultrasonic sensor, wherein the ultrasonic sensor comprises:
a substrate;
a piezoelectric transducer on the substrate; and
a first chip on the substrate and electrically connected to the piezoelectric transducer, the first chip including one type of a transmitter chip, a receiver chip, or an integrated chip, wherein the integrated chip integrates circuits of the transmitter chip and the receiver chip.

19. An electronic device, comprising:
a fingerprint recognition apparatus comprising an ultrasonic sensor, the ultrasonic sensor comprising:
a substrate;
a piezoelectric transducer on the substrate; and
a first chip on the substrate and electrically connected to the piezoelectric transducer, the first chip including one type of a transmitter chip, a receiver chip, or an integrated chip, wherein the integrated chip integrates circuits of the transmitter chip and the receiver chip.
